(19) United States
(12) Patent Application Publication
(10) Pub. No.: US 2013/0290845 A1
(43) Pub. Date: Oct. 31, 2013

(54) METHOD AND SYSTEM FOR SENDING VIDEO EDIT INFORMATION

(71) Applicants: Kenneth Alan Rudman, South Pasadena, CA (US); Lee Douglas Shartzer, Valencia, CA (US)

(72) Inventors: Kenneth Alan Rudman, South Pasadena, CA (US); Lee Douglas Shartzer, Valencia, CA (US)

(73) Assignee: THOMSON LICENSING, Issy de Moulineaux (FR)

(21) Appl. No.: 13/996,593

(22) PCT Filed: Dec. 5, 2011
(86) PCT No.: PCT/US2011/065093

§ 371 Date: Jun. 21, 2013

Related U.S. Application Data
(60) Provisional application No. 61/426,487, filed on Dec. 22, 2010.

(51) Int. Cl. G06F 3/01

(52) U.S. Cl. CPC G06F 3/01
USPC 715/716

(57) ABSTRACT

The present invention relates to permitting a user to transmit information concerning a segment of an audio/video program without transmitting the audio/video program. Specifically, the present invention generates a start time of a video edit and a stop time of a video edit in response to a user input, and transmits this information to a recipient along with data identifying the video asset, such that the recipient may apply this information to a copy of the video asset. In addition, this information may be sent to a third party for generating usage statistics, altering access parameters to said video asset, or generating purchase offers for said video asset.

### PRIORITY CLAIM

This application claims the benefit of U.S. Provisional Patent Application No. 61/426,487, filed Dec. 22, 2010, entitled “Method and System for Sending Video Edit Information” which is incorporated herein by reference.

### FIELD OF THE INVENTION

The present invention relates to a method and associated apparatus for editing of a video asset. Specifically, the present invention relates to determining a start time of a video edit, a stop time of a video edit, and transmitting this information to a recipient along with data identifying the video asset, such that the recipient may apply this information to a copy of the video asset.

### BACKGROUND OF THE INVENTION

This section is intended to introduce the reader to various aspects of art, which may be related to various aspects of the present invention that are described below. This discussion is believed to be helpful in providing the reader with background information to facilitate a better understanding of the various aspects of the present invention. Accordingly, it should be understood that these statements are to be read in this light, and not as admissions of prior art.

Increased connectivity due to the internet and social media have driven the desire for people to increasingly share ideas, comments and opinions with friends and family. Increasingly users may wish to share clips or segments of media, however, copyrights often prohibit users from sharing media on the internet. This media may include copyright protected audio and video programming. Even if both users had access to the content, a first user is still prohibited from transmitting the media content to the second user. There exists the need for a first user to share content with a second user without violating copyrights.

### SUMMARY OF THE INVENTION

In accordance with the present invention, a method comprising the steps of generating a representation of an audio/video program, receiving a first input signal indicative of a first time within said audio/video program, receiving a second input signal indicative of a second time within said audio/video program, transmitting a data packet comprising information indicative of said first time, said second time, and an identification of said audio/video program is disclosed.

In accordance with another aspect of the invention an apparatus comprising a source of an audio/video program, an input for receiving a first control signal indicative of a first time point within said audio/video program and a second control signal indicative of a second time point within said audio/video program, a processor for generating a data packet comprising said first time point, said second time point, and data indicative of said audio/video program and an output for coupling said data packet to a transmitter is disclosed.

In accordance with a third aspect of the present invention, a method of displaying video data comprising the steps of receiving data indicating a start time, a stop time, and an indication of an audio/video program, retrieving a representation of said audio/video program, and generating an audio/video stream comprising a portion of said audio/video program bounded by said start time and said stop time is disclosed.

### DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a block diagram showing an exemplary environment for implementing the present invention;

FIG. 2 is a block diagram showing an exemplary receiving device for implementing the present invention;

FIG. 3 is a exemplary on screen display representative of an implementation of the present invention;

FIG. 4 is a state diagram of an exemplary embodiment of the operation of the method according to the present invention.

The examples set out herein illustrate presently preferred embodiments of the invention, and such exemplifications are not to be construed as limiting the scope of the invention in any manner.

### DETAILED DESCRIPTION

As described herein, the present invention permits a user to select a start and end time of a clip of a currently watched or saved program in order to generate a program segment. The program identification data and start and stop times are sent to other users who have access to the content. The data permits the other users to recreate the program segment without having video content distributed between users.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims. The present invention may be implemented in the software or electronics of a satellite or cable television set-top box or other device capable of tuning television signals. The disclosed apparatus and technique may also be used in other signal reception applications.

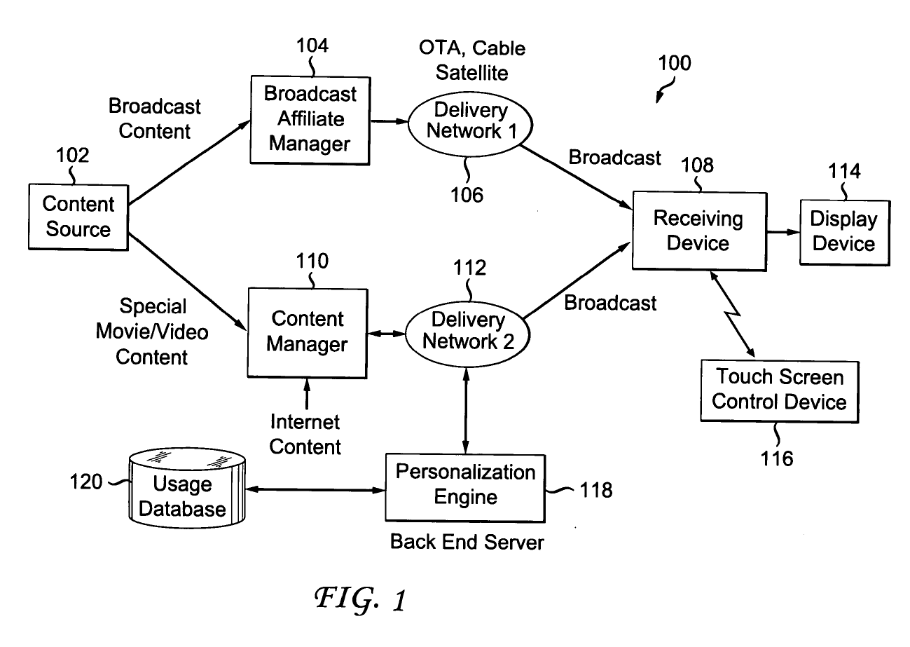

Turning now to FIG. 1, a block diagram of an embodiment of a system 100 for delivering content to a home or end user is shown. The content originates from a content source 102, such as a movie studio or production house. The content may be supplied in at least one of two forms. One form may be a broadcast form of content. The broadcast content is provided to the broadcast affiliate manager 104, which is typically a national broadcast service, such as the American Broadcasting Company (ABC), National Broadcasting Company (NBC), Columbia Broadcasting System (CBS), etc. The broadcast affiliate manager may collect and store the content, and may schedule delivery of the content over a deliver network, shown as delivery network 1 (106). Delivery network 1 (106) may include satellite link transmission from a national center to one or more regional or local centers. Delivery network 1 (106) may also include local content delivery using local delivery systems such as over the air broadcast, satellite broadcast, or cable broadcast. The locally delivered content is provided to a receiving device 108 in a user's home, where the content will subsequently be searched by the user. It is to be appreciated that the receiving device 108 can take many forms and may be embodied as a set top box/digital video recorder (DVR), a gateway, a modem, etc. Further, the receiving device 108 may act as entry point, or gateway, for a home network system that includes additional devices configured as either client or peer devices in the home network.

A second form of content is referred to as special content. Special content may include content delivered as premium viewing, pay-per-view, or other content otherwise not provided to the broadcast affiliate manager, e.g., movies, video games or other video elements. In many cases, the special content may be content requested by the user. The special content may be delivered to a content manager 110. The content manager 110 may be a service provider, such as an Internet website, affiliated, for instance, with a content provider, broadcast service, or delivery network service. The content manager 110 may also incorporate Internet content into the delivery system. The content manager 110 may deliver the content to the user's receiving device 108 over a separate delivery network, delivery network 2 (112). Delivery network 2 (112) may include high-speed broadband Internet type communications systems. It is important to note that the content from the broadcast affiliate manager 104 may also be delivered using all or parts of delivery network 2 (112) and content from the content manager 110 may be delivered using all or parts of delivery network 1 (106). In addition, the user may also obtain content directly from the Internet via delivery network 2 (112) without necessarily having the content managed by the content manager 110.

Several adaptations for utilizing the separately delivered content may be possible. In one possible approach, the special content is provided as an augmentation to the broadcast content, providing alternative displays, purchase and merchandising options, enhancement material, etc. In another embodiment, the special content may completely replace some programming content provided as broadcast content. Finally, the special content may be completely separate from the broadcast content, and may simply be a media alternative that the user may choose to utilize. For instance, the special content may be a library of movies that are not yet available as broadcast content.

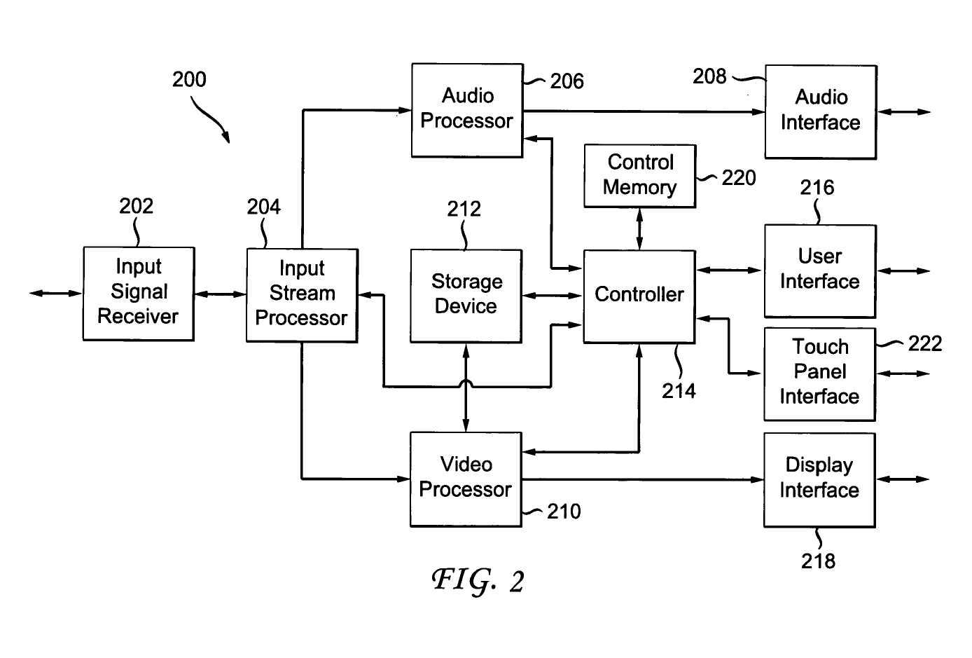

The receiving device 108 may receive different types of content from one or both of delivery network 1 and delivery network 2. The receiving device 108 processes the content, and provides a separation of the content based on user preferences and commands. The receiving device 108 may also include a storage device, such as a hard drive or optical disk drive, for recording and playing back audio and video content. Further details of the operation of the receiving device 108 and features associated with playing back stored content will be described below in relation to FIG. 2. The processed content is provided to a display device 114. The display device 114 may be a conventional 2-D type display or may alternatively be an advanced 3-D display.

The receiving device 108 may also be interfaced to a second screen such as a touch screen control device 116. The touch screen control device 116 may be adapted to provide user control for the receiving device 108 and/or the display device 114. The touch screen device 116 may also be capable of displaying video content. The video content may be graphics entries, such as user interface entries, or may be a portion of the video content that is delivered to the display device 114. The touch screen control device 116 may interface to receiving device 108 using any well known signal transmission system, such as infra-red (IR) or radio frequency (RF) communications and may include standard protocols such as infra-red data association (IRDA) standard, Wi-Fi, Bluetooth and the like, or any other proprietary protocols. Operations of touch screen control device 116 will be described in further detail below.

In the example of FIG. 1, the system 100 also includes a back end server 118 and a usage database 120. The back end server 118 includes a personalization engine that analyzes the usage habits of a user and makes recommendations based on those usage habits. The usage database 120 is where the usage habits for a user are stored. In some cases, the usage database 120 may be part of the back end server 118 a. In the present example, the back end server 118 (as well as the usage database 120) is connected to the system the system 100 and accessed through the delivery network 2 (112).

Turning now to FIG. 2, a block diagram of an embodiment of a receiving device 200 is shown. Receiving device 200 may operate similar to the receiving device described in FIG. 1 and may be included as part of a gateway device, modem, settop box, or other similar communications device. The device 200 shown may also be incorporated into other systems including an audio device or a display device. In either case, several components necessary for complete operation of the system are not shown in the interest of conciseness, as they are well known to those skilled in the art.

In the device 200 shown in FIG. 2, the content is received by an input signal receiver 202. The input signal receiver 202 may be one of several known receiver circuits used for receiving, demodulation, and decoding signals provided over one of the several possible networks including over the air, cable, satellite, Ethernet, fiber and phone line networks. The desired input signal may be selected and retrieved by the input signal receiver 202 based on user input provided through a control interface or touch panel interface 222. Touch panel interface 222 may include an interface for a touch screen device. Touch panel interface 222 may also be adapted to interface to a cellular phone, a tablet, a mouse, a high end remote or the like.

The decoded output signal is provided to an input stream processor 204. The input stream processor 204 performs the final signal selection and processing, and includes separation of video content from audio content for the content stream. The audio content is provided to an audio processor 206 for conversion from the received format, such as compressed digital signal, to an analog waveform signal. The analog waveform signal is provided to an audio interface 208 and further to the display device or audio amplifier. Alternatively, the audio interface 208 may provide a digital signal to an audio output device or display device using a High-Definition Multimedia Interface (HDMI) cable or alternate audio interface such as via a Sony/Philips Digital Interconnect Format (SPDIF). The audio interface may also include amplifiers for driving one more sets of speakers. The audio processor 206 also performs any necessary conversion for the storage of the audio signals.

The video output from the input stream processor 204 is provided to a video processor 210. The video signal may be one of several formats. The video processor 210 provides, as necessary a conversion of the video content, based on the input signal format. The video processor 210 also performs any necessary conversion for the storage of the video signals.

A storage device 212 stores audio and video content received at the input. The storage device 212 allows later retrieval and playback of the content under the control of a controller 214 and also based on commands, e.g., navigation instructions such as fast-forward (FF) and rewind (Rew), received from a user interface 216 and/or touch panel interface 222. The storage device 212 may be a hard disk drive, one or more large capacity integrated electronic memories, such as static RAM (SRAM), or dynamic RAM (DRAM), or may be an interchangeable optical disk storage system such as a compact disk (CD) drive or digital video disk (DVD) drive.

The converted video signal, from the video processor 210, either originating from the input or from the storage device 212, is provided to the display interface 218. The display interface 218 further provides the display signal to a display device of the type described above. The display interface 218 may be an analog signal interface such as red-green-blue (RGB) or may be a digital interface such as HDMI. It is to be appreciated that the display interface 218 will generate the various screens for presenting the search results in a three dimensional gird as will be described in more detail below.

The controller 214 is interconnected via a bus to several of the components of the device 200, including the input stream processor 202, audio processor 206, video processor 210, storage device 212, and a user interface 216. The controller 214 manages the conversion process for converting the input stream signal into a signal for storage on the storage device or for display. The controller 214 also manages the retrieval and playback of stored content. Furthermore, as will be described below, the controller 214 performs searching of content and the creation and adjusting of the gird display representing the content, either stored or to be delivered via the delivery networks, described above.

The controller 214 is further coupled to control memory 220 (e.g., volatile or non-volatile memory, including RAM, SRAM, DRAM, ROM, programmable ROM (PROM), flash memory, electronically programmable ROM (EPROM), electronically erasable programmable ROM (EEPROM), etc.) for storing information and instruction code for controller 214. Control memory 220 may store instructions for controller 214. Control memory may also store a database of elements, such as graphic elements containing content. The database may be stored as a pattern of graphic elements. Alternatively, the memory may store the graphic elements in identified or grouped memory locations and use an access or location table to identify the memory locations for the various portions of information related to the graphic elements. Additional details related to the storage of the graphic elements will be described below. Further, the implementation of the control memory 220 may include several possible embodiments, such as a single memory device or, alternatively, more than one memory circuit communicatively connected or coupled together to form a shared or common memory. Still further, the memory may be included with other circuitry, such as portions of bus communications circuitry, in a larger circuit.

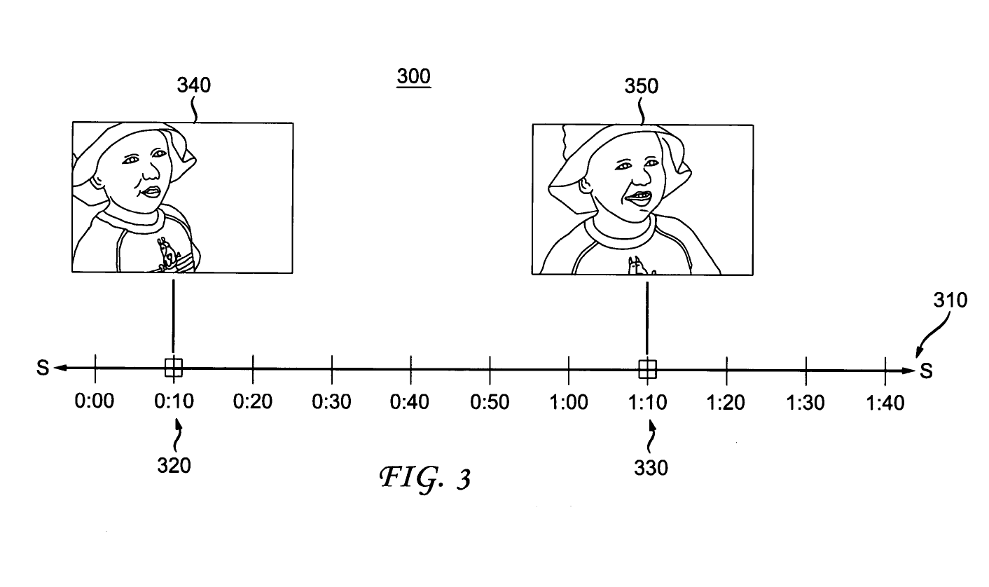

Turning now to FIG. 3, an exemplary on-screen display (OSD) 300 of a timeline of a video program represented by the line shown 310. The user selects a first point 320 along the time line 310 as a start time and a second time 330 along the point as a stop time. These points can be determined and selected by a user in a number of ways. As depicted, the user may select a first time and a second time on an on-screen timeline. Graphical representations of the starting video frame 340 and the stopping video frame 350 may be depicted for aiding the user in determining the desired stop and start times. Alternatively, a user may just fast forward and rewind the program until the desired point of the program is displayed. At that point the user may press a button on the remote control to select the point in the video as a start time. Likewise, the user can then fast forward to the desired stop point and select a button on the remote. During the stop time selection, information about the length of the clip, etc, may be displayed to the user. After the information is selected, at least the program information and the start and stop times are stored as data that can be shared on a network or on the internet.

The users may also select audio of video using a pinch gesture on a touch screen, such as those of tablet PCs or smart phones, where the start and stop times are selected simultaneously on a video timeline. Some secondary gesture, such as a throw to screen may be used to instantaneously share the content on a network, or social network, such as facebook, imdb.net, or the like.

Alternately, a user could select a number of start and stop points to string together a number of video segments. All of this data could be shared by the user in a single information capsule, such as a metadata file, to permit a second user to recreate the desired video string at the second user's location without sharing the actual video data.

Metadata can be used to describe digital data by describing the contents and context of data files. As a result, the quality of the original data/files is greatly increased. For example, a webpage may include metadata specifying what language it's written in, what tools were used to create it, and where to go for more on the subject, allowing browsers to automatically improve the experience of users. Metadata, or metacontent, provides information about the data, such as: means of creation of the data, purpose of the data, time and date of creation, creator or author of data, placement on a computer network where the data was created, standards used, and the basic information of a piece of music. For example, a digital image may include metadata that describes how large the picture is, the color depth, the image resolution, when the image was created, and other data. A text document's metadata may contain information about how long the document is, who the author is, when the document was written, and a short summary of the document.

In broadcast industry, metadata are linked to audio and video broadcast media to identify the media using clip or playlist names, duration, timecode, etc., describe the content using notes regarding the quality of video content, rating, description, and/or classify the media using metadata allow to sort the media or to easily and quickly find a video content.

Additionally, a user can further edit a selected timeline before transmitting it to a second user. For example, a use could edit a video timeline the pinch technique, where the commercials are deleted, by pinching the program line together, where the segments would be “deleted” graphically from the line. The line would then be shorter, but would still represent the program. Likewise, the program could be pulled so that the commercials would reappear in the timeline.

These commercials would then be watched. A user could tap the area representing the first commercial to get more information about the advertisement shown. This would let a user get information about something which they may have previously seen. Typically, if a person is using a PVR, they would rewind the program to display the advertisement again. With this graphical interface, would be able to “jump” or select what you are interested in without having to mess around with trick play functions.

Within the transmission of data, metadata can be transmitted which indicates the various media asset being described and a time code indicates various points of interest which have been shown using this tool. Alternatively, the users may be able to select portions of freely available clips, such as trailers or the like, and transmit data indicating a combination of clips, or a portion of a clip to other users on the system. Metadata would also be stored indicating where the content is available on the network. If a second user has access to the content, the second user would be able to view the first users edited sequence.

Information about the edited clips and number of shares/views could be sent back to the content provider giving real time feedback on what users consider to be the most desirable clips. This information could be used in advertising, etc. The service provider and/or content provider may also track recommendations and when they lead to purchases.

A service provider may also use this ability to create playlists of video portions from the video program, permitting viewers to select the most appropriate video edit for their uses. For example, in a documentary, if a users desires a 30 minute documentary, the most important 30 minutes of a 2 hour documentary could be linked together skipping the least important 90 minutes. This would permit a user to watch content where time constraints would not permit the watching of the entire content. Additionally, video segments could be ranked in order of importance and users could indicate the amount of time available to watch the content and an edited program list could be generated including only the most important segments that would fit into that available amount of time.

Additionally, if some content is not available for sharing, such as music in a video segment, the system provider may prevent that segment of video from being selected within the start stop limits. Areas can be defined where clips can be made and where clips cannot be made, such as areas where unlicensed music is in the forbidden clips.

Additionally, service or content providers may permit a user to retain use of the selected video stream event after access to the entire content is lost. For instance, users may select and retain access to their favorite 4 minutes of a movie transmitted on demand. This start stop content data is stored on their system and access to the favorite 4 minutes is retained even after access to the content, such as a pay per view event, or an on demand video is expired.

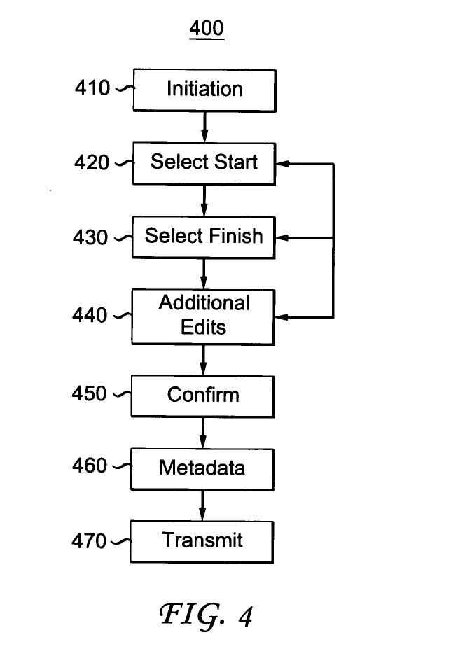

Turning now to FIG. 4, a state diagram of an exemplary embodiment of the operation of the method according to the present invention is shown 400. In some manner, the user initiates 410 the edit subroutine in order to start the video editing process. The device may display an on-screen display in order to guide the user through the process as described earlier. The user selects 420 a start time for the video segment. The user selects 430 a stop time for the video segment. The user performs any additional edits 440 desired, such as those described earlier. It should be noted that a user may iteratively change the start time, stop time, and edits in any order. Once the editing is complete, the user confirms the edit 450. The device compiles the start time, stop time, and additional edit information, combines this information with the metadata 460 indicating the specific content that was edited, and/or the location of this content on the network or on the internet. This data is then transmitted to the second user 470 via email, text, or other known communication method. Once the second user receives the data and initiates the playback of the data, the second users device retrieves the correct video content, commences display at the start time, ends at the stop time, and edits the video in a manner consistent with the first users selections.

It should be understood that the elements shown in the FIGS. may be implemented in various forms of hardware, software or combinations thereof. Preferably, these elements are implemented in a combination of hardware and software on one or more appropriately programmed general-purpose devices, which may include a processor, memory and input/output interfaces.

The present description illustrates the principles of the present disclosure. It will thus be appreciated that those skilled in the art will be able to devise various arrangements that, although not explicitly described or shown herein, embody the principles of the disclosure and are included within its spirit and scope.

All examples and conditional language recited herein are intended for informational purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

Although embodiments which incorporate the teachings of the present disclosure have been shown and described in detail herein, those skilled in the art can readily devise many other varied embodiments that still incorporate these teachings. Having described preferred embodiments for a method and system for passing content between main screen and secondary screen (which are intended to be illustrative and not limiting), it is noted that modifications and variations can be made by persons skilled in the art in light of the above teachings.

1. A method comprising the steps of:
generating a representation of an audio/video program;
receiving a first input signal indicative of a first time within said audio/video program;
receiving a second input signal indicative of a second time within said audio/video program;
transmitting a data packet comprising information indicative of said first time, said second time, and an identification of said audio/video program.

2. The method of claim 1 wherein said identification of said audio/video program comprises metadata.

3. The method of claim 1 further comprising the steps of:
receiving a third input signal indicating a third time within said audio/video program;
receiving a fourth input signal indicating a fourth time within said audio/video program; and
wherein said data packet further comprises information indicative of said third time and said fourth time.

4. The method of claim 1 wherein said first input signal and said second input signal are generated in response to an indication of two points on a touch screen.

5. The method of claim 1 further comprising the steps of:
generating an information about a video segment in response to receiving said first input; and
generating a video signal comprising said information.

6. The method of claim 1 further comprising the step of:
transmitting said data packet to a third party, such that said third party may generate usage statistics in response to said data packet.

7. The method of claim 1 further comprising the step of:
transmitting said data packet to a third party, such that said third party may alter content access restrictions in response to said data packet.

8. An apparatus comprising:
a source of an audio/video program;
an input for receiving a first control signal indicative of a first time point within said audio/video program and a second control signal indicative of a second time point within said audio/video program;
a processor for generating a data packet comprising said first time point, said second time point, and data indicative of said audio/video program; and
an output for coupling said data packet to a transmitter.

9. The apparatus of claim 8 wherein said data indicative of said audio/video program comprises metadata.

10. The apparatus of claim 8 wherein said input is further operative to receive a third input signal indicating a third time within said audio/video program and to receive a fourth input signal indicating a fourth time within said audio/video program; and wherein said data packet further comprises data indicative of said third time and said fourth time.

11. The apparatus of claim 8 wherein said first input signal and said second input signal are generated in response to an indication of two points on a touch screen.

12. The apparatus of claim 8 further comprising:
a display output for generating a video signal comprising an information about a video segment in response to said first input.

13. The apparatus of claim 8 wherein said output is further operative to couple a second data packet to said transmitter for reception by a third party, such that said third party may generate usage statistics in response to said data packet.

14. The apparatus of claim 8 wherein said output is further operative to couple a second data packet to said transmitter for reception by a third party, such that said third party may alter content access restrictions in response to said data packet.

15. A method of displaying video data comprising the steps of:
receiving data indicating a start time, a stop time, and an indication of an audio/video program;
retrieving a representation of said audio/video program; and
generating an audio/video stream comprising a portion of said audio/video program bounded by said start time and said stop time.

16. The method of claim 15 wherein said retrieving step further comprising comparing said data to metadata of an audio/video program.

17. The method of claim 15 wherein said retrieving step further comprising comparing said data to a database.

18. The method of claim 15 wherein said retrieving step further comprising downloading said audio/video program via a network.

19. The method of claim 15 further comprising the steps of:
generating an on-screen display comprising a purchase offer.

20. The method of claim 15 further comprising the steps of:
receiving a first input signal indicative of a first time within said audio/video program;
receiving a second input signal indicative of a second time within said audio/video program;
transmitting a data packet comprising information indicative of said start time, said stop time, said first time, said second time, and an identification of said audio/video program.
